(19) United States
(12) Patent Application Publication
(10) Pub. No.: US 2016/0025351 A1
(43) Pub. Date: Jan. 28, 2016

(54) OPTIMIZED BAKING CHAMBER PRESSURE

(71) Applicant: MIWE Michael Wenz GmbH, Arnstein (DE)

(72) Inventors: Michael Koos, Arnstein (DE); Bernd Pfeuffer, Obersfeld (DE); Hermann Spaeth, Geiselhoering (DE)

(21) Appl. No.: 14/795,029

(22) Filed: Jul. 9, 2015

(30) Foreign Application Priority Data
Jul. 23, 2014 (DE) 102014110376.9

(51) Int. Cl. F24C 15/00; A23L 1/01

(52) U.S. Cl. CPC F24C 15/003; A23L 1/0121; F24C 15/00

(57) ABSTRACT

The system described herein relates to a baking oven having a baking chamber which is provided with an outlet opening leading to a flue. Air is able to escape from the baking chamber through the outlet opening. A fresh air opening with a motor-adjustable flow cross section is provided between the baking chamber and the surroundings. The system adjusts the pressure conditions within the baking chamber optimally throughout the baking operation. A pressure sensor measures pressure in the baking chamber and passes the measurement signals to a control unit which controls the adjustable flow cross section of the fresh air opening on the basis of the measurement signals from the pressure sensor.

### TECHNICAL FIELD

This application relates to a baking oven having a baking chamber and more particularly to a baking oven having a baking chamber in which pressure is optimized.

### BACKGROUND OF THE INVENTION

Modern baking ovens have a vapor outlet which is formed by an outlet opening connected to a flue and through which steam, which is fed to the baking chamber, and baking loss are passed to a flue. The baking loss is the weight proportion which is lost from the baked dough preforms during the baking operation and consists predominantly of water. The flue generally has a draft related to the type of construction and temperature, i.e. a negative pressure arises in the flue that ensures that the vapors and gases in the flue are sucked from bottom to top. The flue draft influences the pressure of the baking atmosphere in the baking chamber of the baking oven. A flue with a strong draft generates a considerable negative pressure in the baking chamber. By contrast, if the flue has only a weak draft, a relatively small negative pressure arises of the order of about 5 Pa. The draft of the flue is also weather-dependent. In cold weather, on account of the large temperature differences, a strong draft generally arises, and consequently a large negative pressure in the baking chamber.

The pressure conditions in the baking chamber have a considerable influence on the quality of the baking result. A smaller pressure in the baking chamber can result, for example, in reduced heat transfer to the dough preforms introduced into the baking chamber. In response to this, the baking time has to be increased in order to achieve the desired baking result, i.e. the desired browning and crispness of the crust produced during baking. The increased baking time reduces the productivity of the baking oven and increases the energy consumption required to achieve a particular baking result. In addition, the baker has to use his or her experience to compensate for the draft that varies on account of the weather, by increasing the baking time.

During baking, the dough preforms are generally subjected to steam. This vapor feed, as it is known, increases the heat transfer and ensures a desired consistency of the surface of the baked goods. The feed of the baking vapor also has an influence on the pressure conditions inside the baking chamber.

The fresh air opening is opened a few minutes before the end of the baking process in conventional baking ovens. Depending on the baked good, early opening of the fresh air opening is also necessary in order to achieve the desired baking result. For example, the fresh air opening is opened early in the case of lye pretzels. Baking with the fresh air opening opened has the disadvantage that cold air is admixed with the baking atmosphere.

A device for the thermal treatment of foodstuffs is known from the document DE 102 45 773 C1, which describes a switchover valve which connects the cooking chamber exhaust air opening to the cooking chamber supply air opening in a bypass position and guides supply air from the appliance supply air opening into the cooking chamber and guides exhaust air via the appliance exhaust air opening out of the appliance exhaust air opening in a throughflow position. Regulation of the cooking chamber pressure is not addressed here. Only the positive pressure at the cooking chamber exhaust air opening is limited by a nonreturn valve, which opens from a determined pressure difference of more than 50 mbar.

The document DE 10 2008 012 395 A1 shows a device for regulating the difference in the pressure upstream and downstream of a throttle valve. Regulation of the baking chamber pressure is not addressed here, either.

Accordingly, it is desirable to be able to set the pressure conditions within the baking chamber optimally throughout the baking operation.

### SUMMARY OF THE INVENTION

According to the system described herein, a pressure sensor measures the pressure in the baking chamber and passes the measurement signals to a control unit which controls the adjustable flow cross section of the fresh air opening on the basis of the measurement signals from the pressure sensor, where the control unit is settable such that ambient pressure prevails in the baking chamber during the baking operation.

The system described herein provides that the pressure within the baking chamber is measured during the baking operation and the adjustable flow cross section is regulated via a control unit such that a desired pressure arises within the baking chamber. Ambient pressure may be set within the baking chamber. The aim is what is known as “atmospheric baking” or baking at atmospheric pressure. The dough preforms are fed to the baking chamber at ambient pressure (atmospheric pressure). In previous baking ovens, a negative pressure arose during the baking operation, resulting in the gas bubbles enclosed in the dough preform being at a lower pressure than atmospheric pressure. When the finished baked goods were removed from the baking chamber, the resulting baked goods were subjected to the higher atmospheric pressure again, with the result that the gases enclosed in the baked goods were compressed and the dough preforms shrank. According to the system described herein, it is now possible to largely reduce pressure fluctuations. The controller controls the pressure within the baking chamber on the basis of the measurement signal from the pressure sensor. Thus, a closed control circuit is produced. With this control circuit, the baking chamber pressure can be kept at a predetermined value, in particular at ambient pressure. During the baking operation, an internal pressure corresponding to atmospheric pressure prevails in the dough preforms baked at ambient pressure. Shrinkage on account of pressure equalization following removal from the baking oven is consequently eliminated. In particular Danish pastries, that is to say baked goods that rise loosely, achieve a large volume and have improved consistency.

Compared with the previously known uncontrolled fresh air opening, the controller allows a very much smaller opening of the opening throughout the baking operation. As a result, the quantity of fresh air flowing in is much less and energy can be saved.

The adjustable flow cross section for the fresh air opening can have at least one of the following devices:
a fresh air flap that is swingable open and closed;
a slider which opens or closes the flow cross section.

A fresh air flap largely frees the flow cross section when the fresh air flap is oriented at right angles to a pipe connector in which the fresh air flap is fitted. If the fresh air flap is flapped closed, the flow cross section is closed. A slider can close, partially free and completely open the flow cross section. Other known devices can be used to set the degree of opening of a flow cross section.

In practice, the pressure sensor can be arranged outside the baking chamber, and a flow line that leads into the baking chamber can subject the pressure sensor to baking chamber pressure. This has the advantage that the pressure sensor can be arranged in a relatively cold zone of the baking oven. Pressure sensors which are functional at a baking chamber temperature of much greater than 200 degrees are relatively expensive. As a result of arranging the pressure sensor in a cool zone outside the baking chamber, the susceptibility to faults of the device described herein is reduced.

In practice, the pressure sensor can be a differential pressure sensor which measures the pressure difference between the baking chamber pressure and the ambient pressure. A differential pressure sensor generally has two measuring chambers between which a diaphragm is arranged. The deflection of the diaphragm is a measure of the pressure difference between the two chambers. The first chamber is subjected to baking chamber pressure. The second chamber is subjected to ambient pressure. When baking is carried out at ambient pressure with the device described herein, the control unit should be set such that a measured pressure difference of zero is achieved.

As mentioned above, in practice, the control unit can be settable such that ambient pressure prevails in the baking chamber during the baking operation in order to achieve optimal baking results. This setting can be selected for the entire baking operation, although no fresh air is fed during steam injection, i.e. the feeding of hot steam, in order to allow the baking vapor to act optimally.

In addition, in practice, it is possible for the baking oven not to have a vapor hood in the region above the door opening. Previous baking ovens had a vapor hood as a matter of principle, in order to collect the moist baking atmosphere which emerged from the baking oven when the door was opened. Since, as a result of the continuous feed of fresh air, the pressure in the baking chamber is kept at ambient pressure, it is not possible for a pressure gradient, which could drive the baking atmosphere outward through the baking oven door, to exist when the door is opened. Furthermore, as a result of the continuous feed of fresh air, a homogeneous baking atmosphere arises without particularly high air humidity or vapor content, and so the baking oven can be opened safely even without a vapor hood. In addition to the vapor hood, it is also possible to dispense with the pipework for the vapor hood and special ventilation of the room in which the baking oven is located. This results in considerable savings for the baker.

The system described herein also relates to a method for operating a baking oven having a baking chamber which is provided with an outlet opening leading to a flue, air being able to escape from the baking chamber through the outlet opening, and which has a fresh air opening with a motor-adjustable flow cross section between the baking chamber and the surroundings.

In order to achieve the abovementioned object, the method described herein includes the following steps:
a pressure sensor measures the pressure in the baking chamber,
the measurement signals from the pressure sensor are passed to the control unit,
the control unit controls the degree of opening of the adjustable flow cross section on the basis of the measurement signals from the pressure sensor, and
the control unit controls the degree of opening such that ambient pressure prevails in the baking chamber during the baking operation.

In practice, the pressure sensor can be arranged outside the baking chamber and a flow line that leads into the baking chamber can subject the pressure sensor to baking chamber pressure.

In practice, the control unit can control the degree of ventilation such that ambient pressure prevails in the baking chamber during the baking operation.

In practice, steam can be fed to the baking chamber by a vapor apparatus, where the baking chamber pressure is not set to ambient pressure during the steam injection operation. This measure ensures that at increased pressure the vapor acts intensively on the dough preforms introduced into the baking chamber. If the baking operation is continued after steam injection, which is discernible, for example, in the case of a convection rack oven by the fact that the fan that circulates the baking atmosphere is reactivated, the opening cross section for the fresh air opening is controlled again such that ambient pressure prevails in the baking chamber.

### BRIEF DESCRIPTION OF THE DRAWINGS

Embodiments of the system described herein will be explained on the basis of the figures, which are briefly described as follows.

FIG. 1 shows a three-dimensional view of the baking oven described herein.

FIG. 2 shows a front view of the baking oven from FIG. 1.

FIG. 3 shows a plan view of the baking oven from FIG. 1.

FIG. 4 shows the detail “A” from FIG. 2.

FIG. 5 shows a control diagram for the baking oven described herein.

### DETAILED DESCRIPTION OF VARIOUS EMBODIMENTS

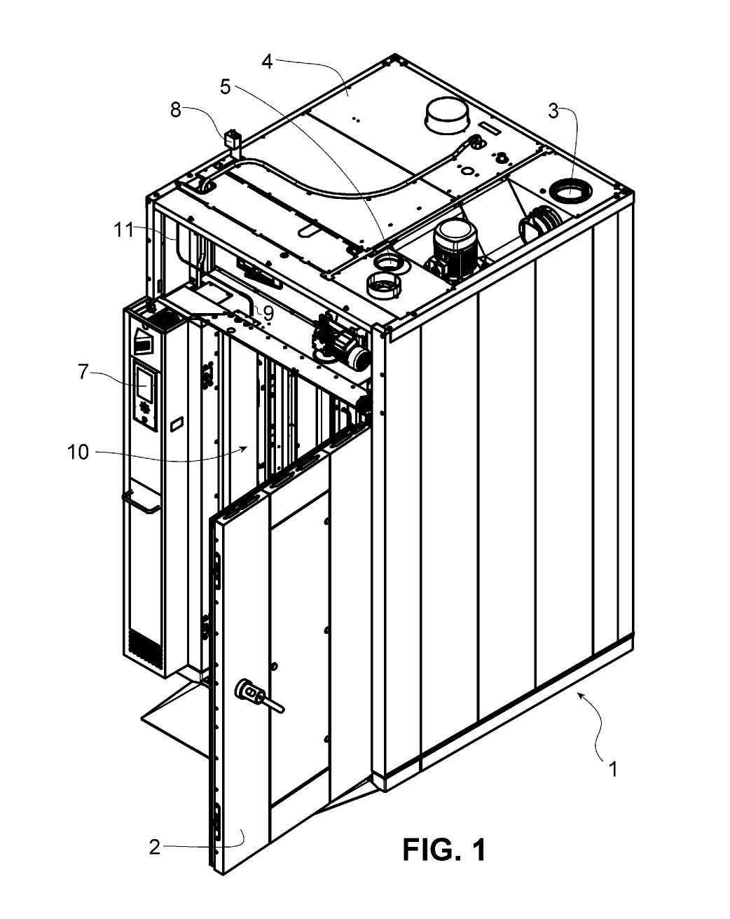

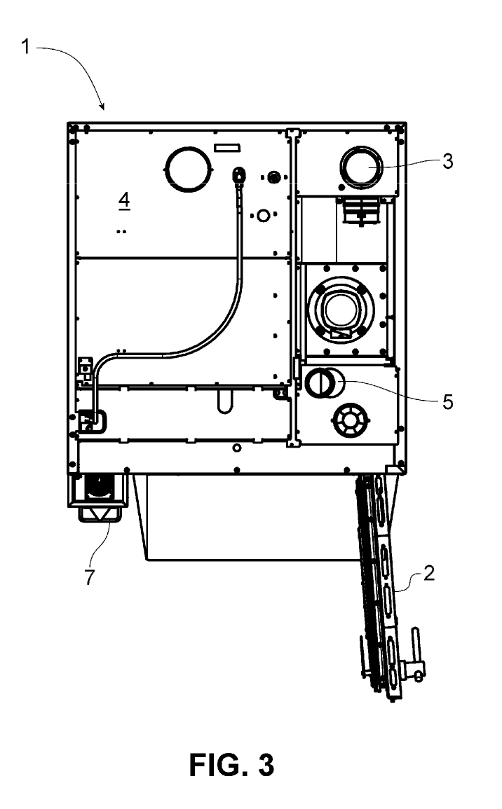

The baking oven 1 illustrated in FIGS. 1-3 is a rack oven into which a rack trolley, also known as a baking trolley, can be introduced. The rack trolley has a number of baked good carriers arranged one above another, on which in each case a multiplicity of dough preforms to be baked are arranged.

The baking oven 1 has a door 2 which closes a baking chamber 10. The baking chamber 10 has, in the baking oven 1, a height of about 2 m and a width and depth of in each case more than 1 m. Arranged above the baking chamber 10 is a heating element (not shown) and a fan (not shown).

The baking oven 1 has a top wall 4 in which an outlet opening 3 is arranged. The outlet opening 3 leads to a flue (not shown). The outlet opening 3 forms the vapor outlet and also serves for the outlet of the baking loss, i.e. the weight proportion of the dough preforms which emerges from the dough preforms during the baking operation. The outlet opening 3 is connected to a flue through which the exhaust gases from the burner of the oven are also guided. The flue, by design, develops a draft, i.e. on account of the temperature differences, suction or negative pressure arises at the bottom end of the flue. The suction or negative pressure ensuring that the vapors and gases in the flue are aspirated upward. The flue draft varies depending on the structural type and on the temperature conditions. Consequently, for each baking oven, a different pressure prevails at the outlet opening 3, and so an individual pressure is set in the baking chamber 10 of each baking oven, too.

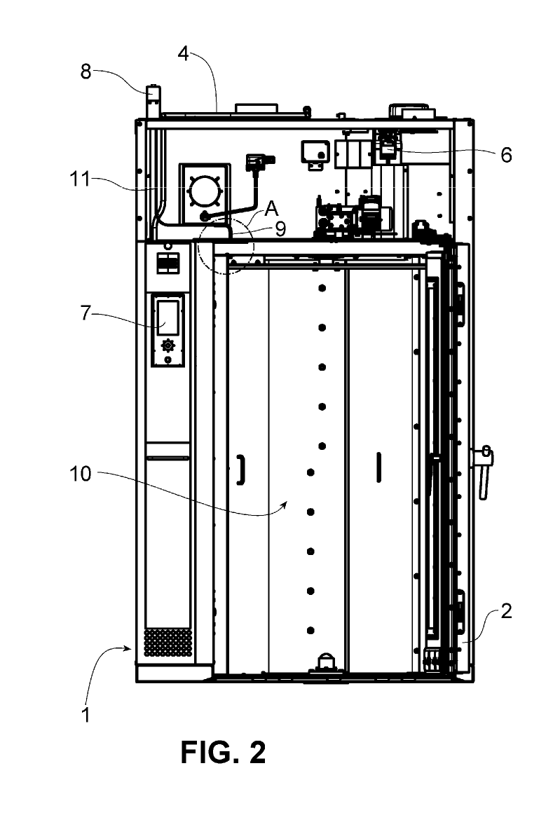

Furthermore, a fresh air opening 5 can be seen in the upper top wall 4 of the baking oven 1. Arranged in the fresh air opening 5 is a closure device (not illustrated). An actuator 6 (see FIG. 2) adjusts the closure device in order to continuously set the degree of opening of the flow cross section of the fresh air opening 5 between the states “completely open” and “completely closed”. The actuator 6 is controlled via a control unit 7 of the baking oven 1.

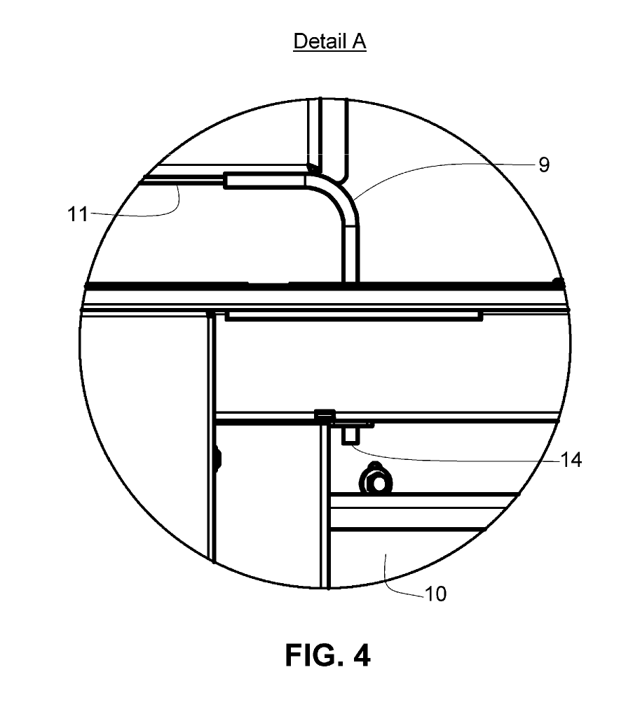

In the central region of the top wall 4 of the baking oven 1, a pressure sensor 8 can be seen. The pressure sensor 8 is in this case a differential pressure sensor having two measuring chambers. In one measuring chamber, the ambient pressure outside the baking oven 1 prevails. The second measuring chamber is subjected to the pressure in the baking chamber 10 of the baking oven 1. For this purpose, a small angled pipe 9 close to the door projects into the baking chamber 10. The small pipe 9 is illustrated on an enlarged scale in FIG. 4. The bottom end 14 of the small pipe 9 leads into the baking chamber 10. Arranged at the upper angled end of the small pipe 9 is a pressure line 11 which passes the pressure in the baking chamber 10 to the pressure sensor 8. Since the pressures to be transferred differ only little from ambient pressure, the pressure line 11 can be configured as a flexible tube. The pressure sensor 8 is arranged outside the baking chamber 10 above the top wall 4 in an assembly space. Significantly lower temperatures prevail outside the baking chamber 10 than in the baking chamber 10, and so the longevity and reliability of the pressure sensor 8 is considerably increased. The pressure sensor 8 is coupled to the control unit 7 by means of signal lines and transfers the measurement signals to the connected control unit 7.

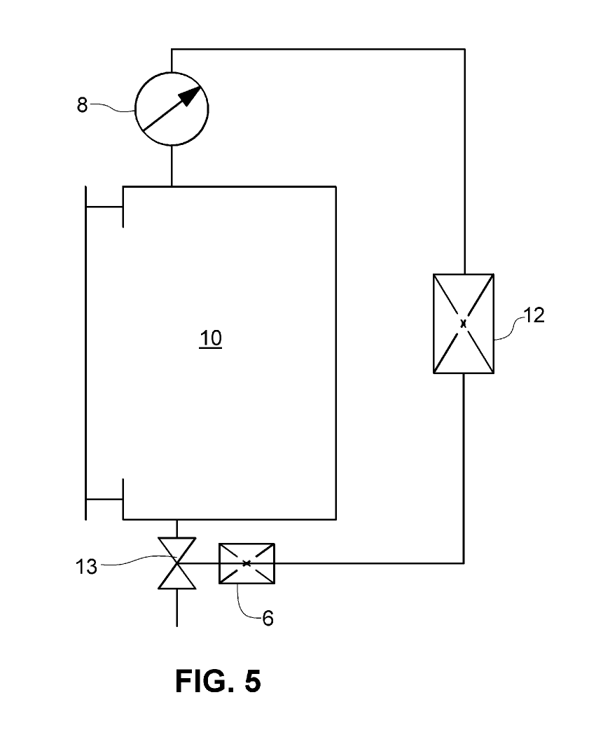

FIG. 5 shows the control circuit of the baking oven described herein. The pressure within the baking chamber 10 is measured by the pressure sensor 8 as a differential pressure compared with the ambient pressure prevailing outside the baking chamber 10. A regulator 12, which is a constituent part of the control unit 7, controls the drive motor 6 for a closure device 13 of the fresh air opening 5. The closure device 13 is illustrated schematically here. The closure device 13 may consist of a pivotable flap within a pipe connector or of a slider which is pushed into the pipe connector by different amounts. Any desired other mechanical means for varying the flow cross section of the fresh air opening 5 can be used.

In practice, the regulator 12 is operated such that ambient pressure prevails as continuously as possible in the baking chamber 10 during baking, during the operation of the fan in the case of the convection oven described herein. This results in the desired baking result and the desired volume of the baked goods, since the latter are not subjected to varying pressures during the baking operation and in particular the pressure cannot rise at the end of the baking operation and squash the baked goods.

In addition, as a result of the regulation of the pressure in the baking chamber 10 to ambient pressure, the susceptibility of the baking oven 1 to faults is reduced. The continuous admixture of ambient air to the baking atmosphere to a small extent results in homogeneous mixing of the baking atmosphere in the baking chamber 10. Very humid regions in the baking chamber 10, which can result in the formation of condensation, are avoided. Since condensation, which can result in faults in the electronics or can lead to corrosion, is reduced or avoided, the susceptibility to faults is reduced.

In conventional baking ovens, a vapor hood, which collects the humid baking atmosphere emerging from the baking chamber 10, is mounted in front of the assembly space with the pressure line 11 and the drive motor 6. Such a vapor hood can be dispensed with in the case of the oven described herein. The baking atmosphere is at ambient pressure and does not exhibit excessively high humidity at the end of the baking operation, and so an expensive and complicated vapor hood can be dispensed with.

The features of the invention which are disclosed in the present description, in the drawings and in the claims can be essential both individually and in any desired combinations for the realization of the invention in its various embodiments. The invention is not limited to the described embodiments. It can be varied within the scope of the claims and taking the knowledge of a competent person skilled in the art into account.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A baking oven, comprising:
a baking chamber which is provided with an outlet opening leading to a flue, air being able to escape from the baking chamber through said outlet opening;
a fresh air opening with a motor-adjustable flow cross section between the baking chamber and ambient air;
a pressure sensor that measures pressure in the baking chamber;
a control unit, coupled to the pressure sensor, that controls the adjustable flow cross section of the fresh air opening according to measurement signals from the pressure sensor, wherein the control unit is settable to provide ambient pressure in the baking chamber during operation of the baking oven.

2. A baking oven according to claim 1, wherein the adjustable flow cross section includes at least one of: a fresh air flap that is swingable open and closed and a slider that opens or closes the flow cross section.

3. A baking oven according to claim 1, wherein the pressure sensor is arranged outside the baking chamber and a pressure line that leads into the baking chamber subjects the pressure sensor to baking chamber pressure.

4. A baking oven according to claim 3, wherein the pressure sensor is a differential pressure sensor that measures the pressure difference between the baking chamber pressure and the ambient pressure.

5. A baking oven according to claim 1, wherein a region above the door opening does not have a vapor hood.

6. A method for operating a baking oven having a baking chamber which is provided with an outlet opening leading to a flue, air being able to escape from the baking chamber through the outlet opening, and which has a fresh air opening with a motor-adjustable flow cross section between the baking chamber and the surroundings, the method comprising:
a pressure sensor measuring pressure in the baking chamber;
measurement signals from the pressure sensor being passed to a control unit;
the control unit controlling an amount of opening of the adjustable flow cross section according to the measurement signals from the pressure sensor; and
the control unit controlling an amount of opening to cause the baking chamber to be at ambient pressure during operation of the baking oven.

7. A method according to claim 6, wherein the pressure sensor is arranged outside the baking chamber and a flow line that leads into the baking chamber subjects the pressure sensor to baking chamber pressure.

8. A method according to claim 6, wherein steam is fed to the baking chamber by a vapor apparatus, and baking chamber pressure is not caused to be at ambient pressure during injection of steam.
